(19) United States
(12) Patent Application Publication
(10) Pub. No.: US 2024/0283398 A1
(43) Pub. Date: Aug. 22, 2024

(54) SINGLE DEGREE OF FREEDOM FOLDABLE PHOTOVOLTAIC MODULES

(71) Applicant: Sego Innovations, LLC, Salt Lake City, UT (US)

(72) Inventors: Jacob L. Sheffield, Salt Lake City, UT (US); Ian N. D. Esplin, Salt Lake City, UT (US)

(21) Appl. No.: 18/583,472

(22) Filed: Feb. 21, 2024

Related U.S. Application Data
(60) Provisional application No. 63/486,199, filed on Feb. 21, 2023.

(51) Int. Cl. H02S 30/20

(52) U.S. Cl. CPC H02S 30/20

(57) ABSTRACT

Photovoltaic (PV) modules include a plurality of rigid panels and a plurality of solar cells that are secured to the plurality of rigid panels. The plurality of rigid panels are kinematically arranged and connected through foldable joints that have a single degree of freedom such that each of the joints in the plurality of foldable joints fold synchronously to transform the PV module between a collapsed configuration and an expanded configuration.

### CROSS REFERENCE TO RELATED APPLICATION

This application claims priority to U.S. Provisional Patent Application No. 63/486,199, filed on Feb. 21, 2023, which is incorporated herein by reference in its entirety.

### BACKGROUND

Photovoltaic (PV) modules that include a plurality of solar cells are used to charge a wide range of electronic devices. These PV modules may be portable such that they can be easily moved from one location to another and can be broken down into at least three general categories. A first category of portable PV modules may produce up to 50 watts and can be used for activities including backpacking, hiking, personal travel, and other similar activities. Devices that these portable PV modules may be used to charge include, but are not limited to, small cameras, radios, phones, headlamps, power banks, fitness trackers, lighthouse lanterns, and small USB devices. A second category of portable PV modules may produce between 50 and 300 watts and can be used for activities including emergency backup power, tailgating, camping, picnics, and other similar activities. Devices that these portable PV modules may be used to charge include, but are not limited to, power stations, speakers, lights, and essential electronics. A third category of portable PV modules may produce between 500 and 1,000 watts ore more and can be used for applications including home backup power, cabins/yurts, sheds, recreational vehicles, and other similar applications. Devices that these portable PV modules may be used to charge include, but are not limited to, lights, offsetting home power usage with a “plug and play” setup, power banks, and charge stations for essential electronics, such as laptops, fridges, grills, and power tools.

Producing a larger amount of wattage requires a greater number of solar cells—and space—in the module. This prevents large portable PV modules from being used in all activities. For example, hiking may require a first portable PV module that is sufficiently small to fit in a backpack to charge a cellphone or GPS device. Camping may require a portable PV module that is sufficiently small to fit in a trunk of a car but still have sufficient power output to charge lighting, heaters, or a power station. While large PV modules (for example, PV modules falling within the third category) may be capable of satisfying the power needs of hikers and campers, they may be too large to be used in these applications. Relying on PV modules for emergency home backup power, such as natural disasters, can be a reliable backup power option, but there is a tradeoff between higher power output for more versatility and reliability and size/form factor for convenient storing. Therefore, separate portable PV modules are often required for different activities depending not only on the amount of power required, but also on the amount of space available to store and transport the PV modules.

A significant amount of room could be saved if portable PV modules could be folded in a space efficient way. However, even small portable PV modules often do not collapse into a form that, for example, can be easily and safely transported in a backpack or trunk of a car. Portable PV modules are also often include panels that are non-rigid or “floppy” and challenging to work with. This is especially true when trying to mount and position the modules so that the solar cells are at an angle that absorbs a maximum amount of solar energy.

Presently, conventional portable PV module designs lack innovation and fail to captivate. Many portable PV modules fold in halves, or thirds, or fourths, etc. but include joints that have more than a single degree of freedom (“map-fold” configurations). Joints having multiple degrees of freedom make transitioning a module from a folded storage configuration to a use application more difficult, or even impossible to mount or anchor. This is particularly evident in solar blankets characterized by numerous independent folds or requiring unfolding.

The subject matter claimed herein is not limited to embodiments that solve any disadvantages or that operate only in environments such as those described above. Rather, this background is only provided to illustrate one example technology area where some embodiments described herein may be practiced.

### SUMMARY

In one embodiment, a PV module is disclosed. The PV module may include a plurality of rigid panels and a plurality of solar cells secured to the plurality of rigid panels. The plurality of rigid panels may be arranged and connected through foldable joints having a single degree of freedom such that each of the joints in the plurality of foldable joints fold synchronously to transform the PV module between a collapsed configuration and an expanded configuration.

In some embodiments, in the expanded configuration, each of the solar cells in the plurality of solar cells may face a common direction.

In some embodiments, each rigid panel in the plurality of rigid panels may include at least one solar cell. In these embodiments, the solar cells may be in electrical communication.

In some embodiments, the foldable joints may include at least one hinge.

In some embodiments, in the collapsed configuration, the PV module may have a substantially square two-dimensional shape. In these embodiments, the substantially square two-dimensional shape may have a truncated corner.

In some embodiments, surfaces of only two rigid panels may be exposed in the collapsed configuration, with surfaces of all other rigid panels being folded inward and concealed within a stacked arrangement.

In some embodiments, the PV module may further include a restraining block in at least one foldable joint that prevents the rigid panels from having a completely flat shape in the expanded configuration. In these embodiments, the PV module may have a concave shape in the expanded configuration.

In another embodiment, another PV module is disclosed. The PV module may comprise a first set of joined panels including two or more individual panels connected through one or more first foldable joints and a first set of solar cells secured to the panels in the first set of joined panels. The PV module may also comprise a second set of joined panels including two or more rigid panels connected through one or more second foldable joints and a second set of solar cells secured to the panels in the second set of joined panels. The first set of joined panels may be selectively attachable to second set of joined panels, and when in an attached configuration, the first foldable joints and the second foldable joints may have a single degree of freedom such that each of the first and second foldable joints fold synchronously to transform the PV module between a collapsed configuration and an expanded configuration.

In some embodiments, the first set of joined panels may be selectively attachable to the second set of panels through a magnetic connection mechanism or alternative mechanical interlocking mechanism.

In some embodiments, the PV module may include a third set of joined panels that can be selectively attached between the first and second sets of joined panels to form part of the PV module. In these embodiments, the PV module, in the collapsed configuration and without the third set of panels, may have a first length, a first height, and a first width. The PV module, in the collapsed configuration and with the set group of panels, may have a second length, a second height, and a second width. The first and second lengths and the first and second heights may be the same.

In some embodiments, the first set of joined panels, in the expanded configuration, may have a triangular shape, the second set of joined panels, in the expanded configuration, may have a triangular shape, and the third set of joined panels, in the expanded configuration, may have a rectangular shape.

In some embodiments, the third set of joined panels may be selectively attachable to the first and second sets of panels through magnetic connection mechanisms or alternative mechanical interlocking mechanism.

In some embodiments, the third set of joined panels may approximately double an amount of wattage that the first and second sets of solar cells are capable of generating.

In some embodiments, in the collapsed configuration, surfaces of the third set of joined panels may be internal facing.

It is to be understood that both the foregoing summary and the following detailed description are explanatory and are not restrictive of the invention as claimed.

### BRIEF DESCRIPTION OF THE DRAWINGS

Embodiments will be described and explained with additional specificity and detail through the use of the accompanying drawings, in which:

FIGS. 1A-1G illustrate an example of a PV module mounted to a tripod that is fixed/locked in a rigid and semi deployed concave configuration;

FIG. 2 illustrates an example of a PV module that uses mechanical hinges at each joint location;

FIG. 3 illustrates an example of another PV module in a flat configuration with a solar cell pattern consisting of both ½-cut and ¼-cut cells;

FIG. 4 illustrates an example of another PV module in a flat configuration with a solar cell pattern consisting of identical ¼-cut cells distributed across each individual panel;

FIGS. 5A-5C illustrate a mounting mechanism secured to the back of a PV module;

FIG. 6 illustrates an example of another PV module system mounted on a pole;

FIGS. 7A-7D illustrate a first view of a folding sequence of a PV module;

FIGS. 8A-8D illustrate a second view of the folding sequence of the PV module;

FIGS. 9A-9D illustrate a third view of the folding sequence of the PV module;

FIGS. 10A-10C illustrate an example of another PV module;

FIGS. 11A-11C illustrate an example of another PV module;

FIGS. 12A-12C illustrate an example of another PV module;

FIGS. 13A-13E illustrate a first view of a folding sequence of another PV module;

FIG. 14A-14E illustrate a second view of the folding sequence of the PV module;

FIGS. 15A-15C illustrate an example of another PV module;

FIGS. 16A-16C illustrate example foldable offset joints;

FIGS. 17A-17B illustrate a hinge with a hollow channel;

FIGS. 18A-18B illustrate a section view of another example foldable joint; and

FIGS. 19A-19C illustrate an example of another PV module.

### DETAILED DESCRIPTION

The disclosure contained herein provides solutions to the issues and problems identified above. As used herein, the term “node” may refer to a vertex where two or more folds or creases meet. The phrase “degree-4 folding pattern” and “degree-4 vertices” may refer to a folding pattern and vertices where four folds or creases meet at a single node. The phrase “degree-6 folding pattern” and “degree-6 vertices” may refer to a folding pattern and vertices where six folds or creases meet at a single node. The phrase “vertex splitting” may refer to a technique to reduce degree-6 vertices to degree-4 vertices.

The PV modules disclosed herein may include a plurality of interconnected panels, and a plurality of solar cells that are secured to the plurality of panels. In some embodiments, the plurality of panels may be rigid such that they are susceptible to very little flexibility and remain flat or nearly flat even with some pressure applied. The plurality of panels may be connected through foldable joints. These foldable joints may use synchronous, single mobility or single degree of freedom (DOF) folding patterns that are easy to expand and collapse. In their collapsed configuration, the PV modules disclosed herein may fit into a backpack (such as a 30 L pack), a trunk of a car, under a seat, etc. However, the PV modules of the present disclosure have a form factor that can be scaled easily to any size for different applications. The PV modules disclosed herein may also be light-weight and easily lifted, handled, and actuated between expanded and collapsed configurations.

The PV module designs described herein may include one or more sections that each include a plurality of individual panels. These individual panels may include one or more solar cells. The panels may be connected via a plurality of joints that may be folded or creased along the joint to change a shape of the PV module. For example, in some embodiments, PV modules may be folded along one or more joints to transform the PV module between a first configuration in which the PV module is in a folded or collapsed configuration and a second configuration in which the PV module is in an unfolded or expanded configuration.

In some embodiments, the folding configuration of the panels may have only a single degree of freedom (DOF). In these embodiments, all of the foldable joints in a PV module may move in unison and at the same time. The joints in a PV module having a single DOF cannot bend or fold independently of the other joints in the PV module. This folding system is similar to some origami designs that also have single DOF configurations.

Structures having degree-4 folding patterns may have a single DOF. However, structures having degree-6 folding patterns do not have a single DOF. Nodes that include a degree-6 vertex may be reduced to degree-4 vertex through a vertex splitting technique. Through this vertex splitting technique, structures having a single DOF may be achieved with kinematic equivalence. In other words, the folding behavior is equivalent to a triangular pattern, but is constrained to a single DOF.

PV modules that have a single DOF folding configuration may simplify a process for transforming a PV module between a first configuration in which the PV module is in a collapsed or folded state and a second configuration in which the PV module is in an open or unfolded state. For example, transforming a PV module with a single DOF configuration from a collapsed or folded configuration to an expanded or unfolded configuration may only require a user to unfold or open a single joint, as all joints in the module will unfold together with the selected joint.

Similarly, to transform a PV module with a single DOF from an expanded or unfolded configuration to a collapsed or folded configuration may only require a user to fold or collapse a single selected joint, as all joints in the module will fold together with the selected joint.

Folding designs that employ a single DOF configuration may be highly stowable and portable. For example, PV modules that have a single DOF configuration and that can produce from 5 to 100 watts, or more, can easily fit into a standard 30-liter backpack. These single DOF configuration designs also add the benefit of achieving large stowed-to-deployed ratios, thereby achieving greater power capability at a lower space consumption. The efficiency achieved by single DOF configuration designs is a significant improvement over multiple rectangular fold designs (or “map-fold” designs), which have larger than single DOF configurations and cannot be rigidly deployed and mounted.

Having a folding solar panel that can be rigidly deployed and remain rigid in their deployed state are especially beneficial for versatile mounting scenarios. Rigid-deployable, single DOF folding solar panels combine the structural strengths of rigid permanent solar panels with the portability advantages of folding panels, making them better than a traditional portable folding panel with the benefits of a rigid panel. A rigid-deployed solar panel can be easily mounted by a single anchoring point on the rear of the panel which fixes the single DOF in a deployed state, and can be mounted to a tripod, pole, or other mount.

In addition to the mechanical advantages associated with PV modules having a single DOF configuration described above, the PV modules presented herein may also provide important aesthetic attributes that easily distinguish these PV modules from others. The efficiency, brand, age, or quality of PV modules that are currently available to the public are generally not easily discernible, especially by a member of the general public or those without expert knowledge of solar voltaic cell technology. The main point of differentiation between many of these PV modules is based on solar cells and substrate, which are not easily perceivable. Due to the relative aesthetic homogeneity (black/gray color, square/rectangular form) of solar cells, they have become commoditized to a certain extent and lack interesting mechanical properties that distinguish one PV module from another.

The PV modules described herein may also be configured to receive inserts or extensions that include additional panels and solar cells, thereby increasing the power generating capabilities of the module. For example, in some embodiments, a PV module may include a first set of joined panels having one or more solar cells attached thereto. The PV module may include a second set of joined panels, which may also have solar cells attached thereto. The first and second set of joined panels may be selectively connectable and detachable. When connected, the first and second sets of joined panels may include a single DOF folding pattern. In one embodiment, each set of panels may include three connected panels, resulting in six total panels.

In some embodiments, the PV module may include a third set of joined panels that form an insert or extension to the first and second sets of joined panels. The third set of joined panels and associated solar cells and may be selectively attachable to one or both of the first and second sets of joined panels. When connected, the mobility of the third set of joined panels may be synchronized with the first and second sets of joined panels to maintain the single DOF folding pattern. Any number of additional sets of joined panels, or inserts, may be added to a first and/or second set of joined panels. In one embodiment, the first and second sets of joined panels may contain three individual panels while the third set may contain ten individual panels.

Each set of joined panels, including the one or more inserts, may be connectable to each other via any number of different interlocking connecting mechanisms. For example, the sets of joined panels may be selectively attachable to each other via a magnetic attachment, a clipping mechanism, a snapping mechanism, a latching mechanism, a bolting mechanism, etc. In some embodiments, any number of separate inserts may be connected to a first and/or second set of joined panels. In these embodiments, a user may select a number of inserts to connect depending on the power requirements of a desired use application. In their expanded configuration, the sets of joined panels in the PV module may lie flat or nearly flat.

In some embodiments, the PV module may include two base sections of joined panels that are selectively connectable as described above. These base sections (without any inserts), when connected and in their expanded configuration may have a square or rectangular general shape. These base sections may include a plurality of separate individual panels that are joined together. In some embodiments, when in their collapsed configuration, only a single panel from each of the base sections may be visible from either a top or bottom view. These single panels from each of the base sections, or “end panels,” which when collapsed are visible from a top for bottom view, may be rigid. Other individual panels in the base portions may be semi-rigid or less rigid than the end panels.

Similar to these base sections, an insert may also include one or more joints that are configured to transform the insert between a first configuration in which the insert is in a collapsed or folded configuration to a second configuration in which the insert is in an open or unfolded configuration. The joints of the base sections and the insert(s) may together have a single DOF such that by folding a single joint in either a base section or the insert may actuate the folding of all of the joints in the PV module. The inserts, in their expanded configuration may have any shape including square or rectangular shapes.

When the base sections are connected to one or more inserts and are in the expanded configuration, the module may have a hexagonal or irregular hexagonal or other polygonal shape. In the folded or collapsed configuration, the base sections and the insert(s) may have consistent length and width (x and y axes) dimensions. For example, the base sections and insert(s) may have a square, rectangular, circular, or other two-dimensional shape when in the folded or collapsed configuration. Any number of inserts may be added to the base sections without changing this two-dimensional (x and y axes) size and shape in the collapsed configuration. Inserts that are connected to base sections may increase the height (z axis) dimension of the PV module in the collapsed configuration, but not the length and width (x and y axes) dimensions of the module.

While the PV modules of the present disclosure include design elements that are similar to origami designs, unlike origami (which is traditionally performed using a zero-thickness material, such as paper), the PV modules of the present disclosure are made using non zero-thickness materials. To accommodate these materials, designs of the present disclosure may incorporate certain techniques in order to maintain foldability, motion, and kinematics. One thickness accommodation technique that may be used is the “offset panel technique.” Other thickness accommodation techniques, such as the “strained joint technique” with membrane hinges may also be used. This technique, however, may not preserve the rigid kinematics of the design.

In one embodiment, an offset panel technique using living hinges instead of traditional pin joint hinges may be used in one or more joints. Using this technique, the offset panels may be only on the back of the panel where the front panels that have the solar cells are planar and flush when unfolded. The thickness of the offset regions may be approximately 2× the thickness of the panel.

In one embodiment, a PV module may contain 16 individual joined panels, consisting of two squares with a single truncated corner resulting in five sides, four larger triangles, four smaller triangles that are half the area of the larger triangles, and six trapezoidal panels. When in the closed configuration, the final two-dimensional profile resembles a square or rectangle, which may have a single truncated corner.

The PV modules of the present disclosure have a wide variety of possible applications and uses. For example, PV modules of the present disclosure may be used for emergency backup power or in connection with activities including climbing, skiing, snowboarding, hiking, backpacking, fishing, showshoeing, biking boating, beach trips, canoeing, kayaking, picnicking, snowmobiling, ATVing, offroading, camping, rafting, overlanding, tailgating, etc. PV modules of the present disclosure may also be used with cabins, yurts, sheds, recreational vehicles, or connected with a home electrical grid to offset home power needs, etc.

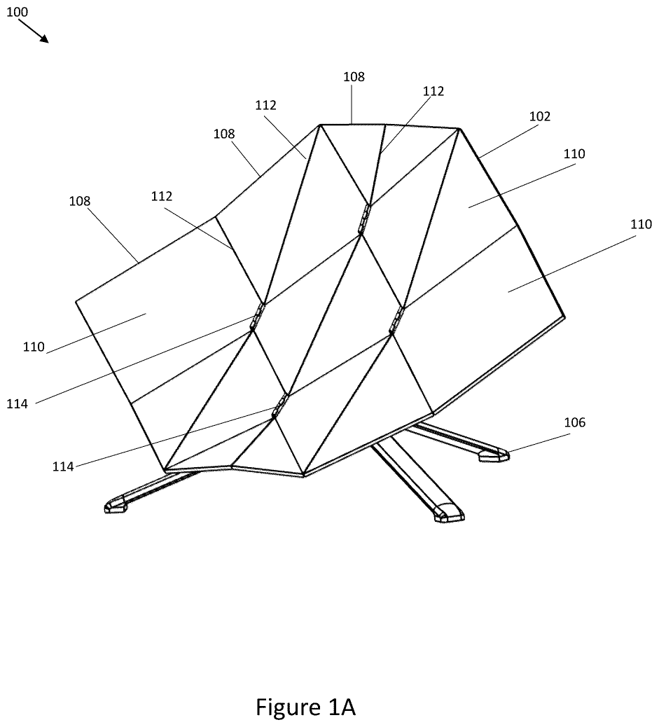

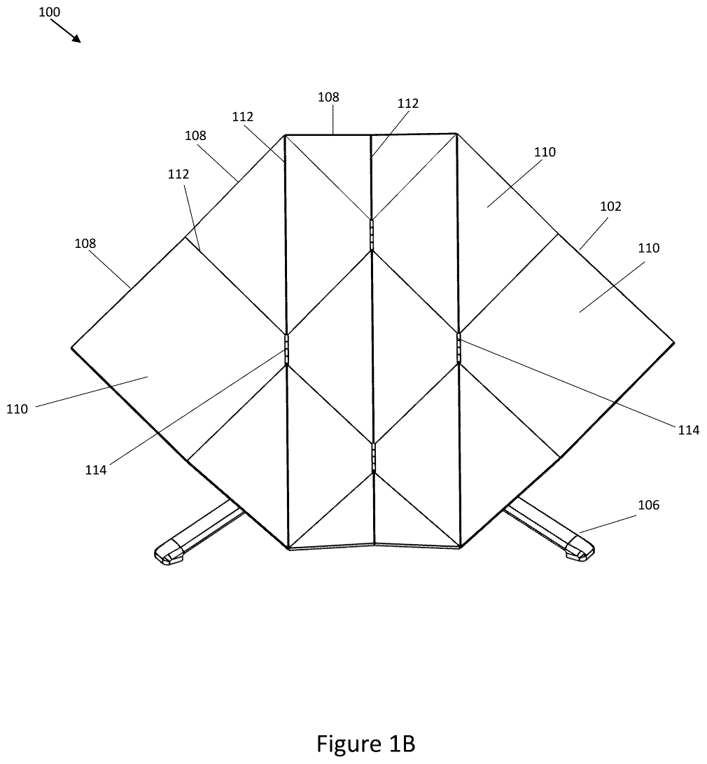

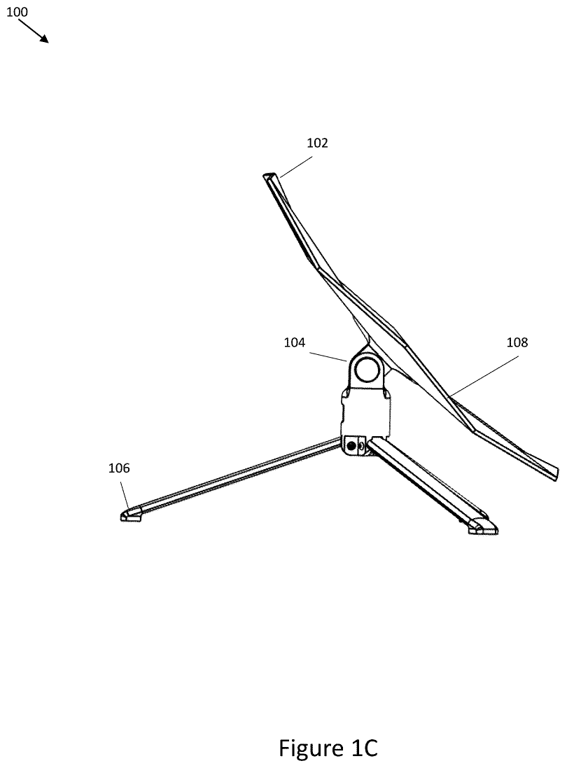

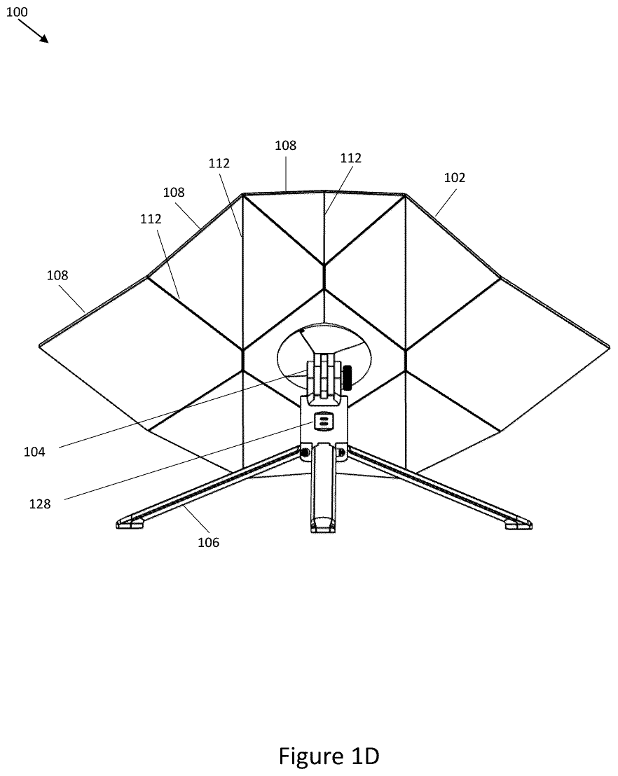

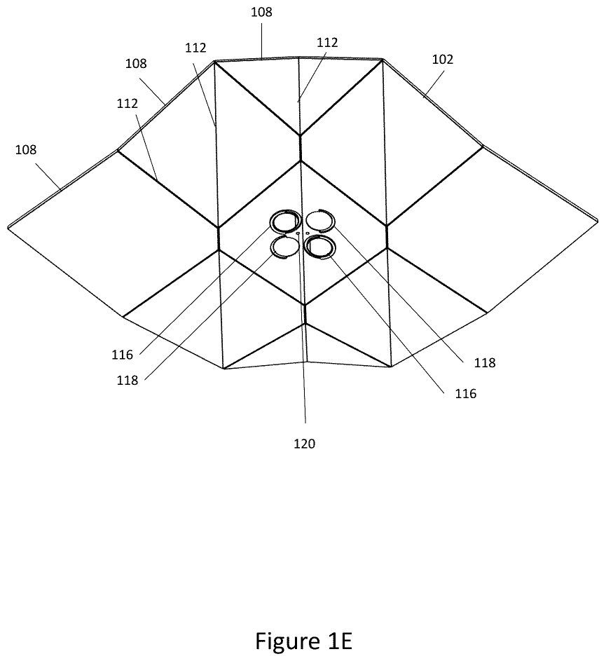

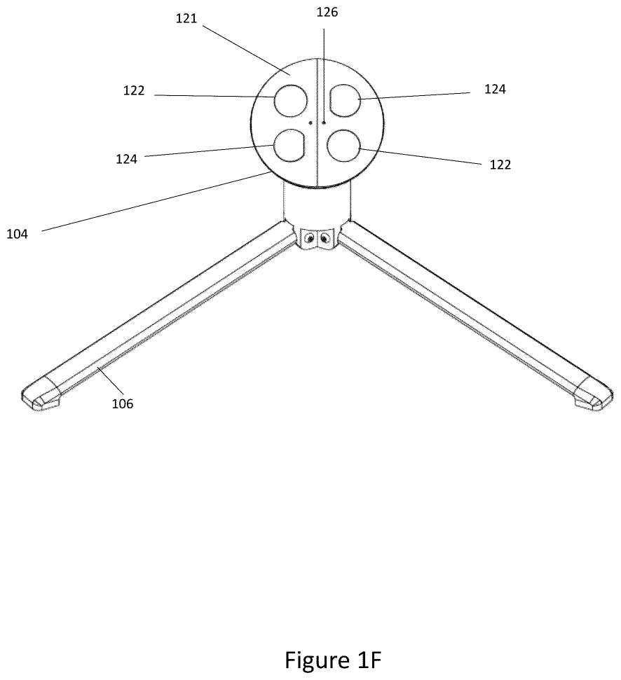

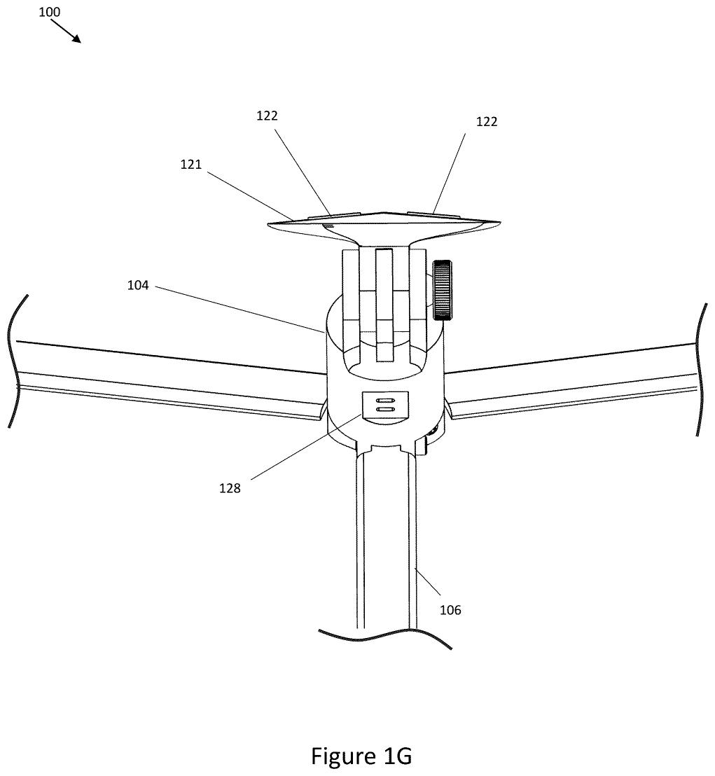

Turning to the Figures, FIGS. 1A-1D illustrates various views of a PV module system 100 that includes a PV module 102, a mounting mechanism 104, and a stand 106. Specifically,

FIG. 1A illustrates a perspective view of the PV module system 100. FIG. 1B illustrates a front view of the PV module system 100. FIG. 1C illustrates a side view of the PV module system 100. FIG. 1D illustrates a back view of the PV module system 100.

The PV module 102 includes a plurality of connected individual panels 108. The panels 108 may be rigid such that they maintain their shapes even under some strain or pressure. The panels 108 may have any number of different shapes and sizes. The panels 108 in the PV module 102 have polygonal shapes. The panels 108 together form a tessellation pattern with no gaps or overlaps between connected panels.

One or more solar cells 110 are secured to the panels 108. The solar cells 110 are configured to generate energy from the Sun. Any number of solar cells 110 may be mounted to the panels 108. Each of the solar cells in the PV module 102 may be in electrical communication such that solar energy generated by the solar cells 110 on the PV module 102 may be consolidated and output to a port (not shown). In some embodiments, the solar cells 110 on PV module 102 may be daisy-chained or connected together with other PV modules (not shown) to increase total power generation.

The panels 108 may be interconnected through foldable joints 112. While some (but not all) foldable joints have been identified with reference number 112, each of the lines between panels 108 indicate a foldable joint. Any folding mechanism may be used for the joints. For example, the joints may be rigid traditional hinges or compliant membranes, or a combination of both. Compliant membranes may allow for an electronic ribbon connection to pass from one solar cell to another solar cell, transferring the accumulated power obtained by the solar cells by each panel. Compliant membrane joints may include compliant mechanism technology, which achieves force and motion transmission through elastic body deformation rather than traditional motion elements, such as hinges or bearings. These mechanisms may be advantageous because they can integrate functions into fewer parts, resulting in lower manufacturing costs and improved performance through reduced wear. These mechanisms may enable panels to conform to geometric constraints and minimize the number of parts to eliminate individual rigid joints and links. Membrane hinges may be fabricated through a single stamping and lamination process to enclose all components of the folding panels, including the rigid backplate, PCB, and solar cells.

Some of the foldable joints 112 in the PV module 102 include mechanical hinges 114. The foldable joints 112 allow the PV module 102 to transform between a collapsed configuration and an expanded configuration. The PV module 102 illustrated in FIGS. 1A-1D is in its expanded configuration. In its expanded configuration, the solar cells generally face in the same direction. This allows the PV module system 100 to be oriented such that the solar cells 110 face toward the Sun to maximize the amount of direct irradiance.

The PV module 102 lacks any nodes having more than a degree-4 vertex. For example, the PV module 102 does not include any degree-6 vertices. A vertex splitting technique may be used to ensure that the nodes in the PV module 102 do not exceed a degree-4 vertex. This allows the PV module 102 to have a single DOF configuration such that each of the foldable joints 112 fold in unison and at the same time. In other words, the foldable joints 112 cannot bend or fold independently of each other; they all fold together.

The PV module system 100 includes a single point mounting mechanism 104 that secures the PV module 102 to the stand 106. The mounting mechanism 104 is selectively connectable to the PV module 102 when the PV module 102 is in an expanded configuration. Any number of different attachment mechanisms may be used to secure a mounting mechanism to a PV module. In some embodiments, the mounting mechanism may be mechanical and use a clip, screw, clamp, or another mechanical connecting device. In other embodiments, the mounting mechanism may be magnetic. FIG. 1E illustrates the back side of the PV module 102 with the mounting mechanism 104 and stand 106 removed. The PV module 102 includes magnets 116 and recesses 118. The magnets 116 and recesses 118 are circular but can have any shape. The magnets 116 may protrude from surfaces of back panels such that the magnets 116 are accommodated within the corresponding recesses 118 to avoid any interference and allow a flush folding interface between panels in the collapsed configuration. Connection pins 120 that deliver power generated by the PV module 102 are also positioned on the back of the PV module 102 proximate the magnets 116 and the recesses 118.

FIG. 1F illustrates a front side of the mounting mechanism 104 and stand 106. An interface surface 121 of the mounting mechanism 104 includes magnets 124 that are positioned to interface with the magnets 116 on the PV module. The interface surface 121 also includes protrusions 122 that are positioned to interface with the recesses 118 in the PV module. The magnets 124 may be slightly recessed in the interface surface 121 of the mounting mechanism 104 to accommodate a flush connection between the interface surface 121 and the back surface of the PV module 102. To ensure a flush connection, the interface surface 121 is not completely flat, but includes two angled faces that align with the angular configurations of the panels 108 when the PV module 102 is in an expanded configuration. These angled faces of the interface surface 121 are shown in FIG. 1G, which illustrates a top view of the mounting mechanism 104 and stand 106.

The mounting mechanism also includes connection ports 126 that are configured to interface with the connection pins 120. Power generated by the PV module 102 may be transferred to the mounting mechanism 104, which also may act as an electrical control box, to convert the energy output from the PV cells into usable power through one or more ports 128, which may include USB type A, USB type C, DC power ports, etc.

The mounting mechanism 104 is selectively adjustable to allow the PV module 102 to be positioned at a desired angle. The stand 106 is a tripod to ensure the stability of the PV module 102 and prevent it from tipping over when deployed.

The PV module 102, when connected to its mounting mechanism, is rigidly fixed to a semi-deployed, concave configuration instead of laying completely flat. This specific setup offers mechanical advantage, facilitating the return of the panels back into their compact, stowed position with minimal effort. As an enhancement to this design, the foldable joints can be outfitted with spring mechanisms. These springs permit the panels to lie flat when deployed fully, yet ensure a smooth, guided return to the folded state upon release of applied forces, maintaining the correct orientation for folding.

Modifications, additions, or omissions may be made to the system 100 without departing from the scope of the present disclosure. For example, in some embodiments, the system 100 may include additional components similar to the components illustrated in FIG. 1 that each may be configured similarly to the components illustrated in FIG. 1. In one such embodiment, a PV module may include solar cells on both sides of the rigid panels to increase power generated from diffuse and reflected irradiance.

FIG. 2 illustrates another embodiment of a PV module 202 according to the present disclosure. Similar to the PV module 102, the PV module 202 includes a plurality of connected individual panels 208 that together form a tessellation pattern with no gaps or overlaps between connected panels. The panels 208 are interconnected through a plurality of joints 212. Some of these joints include hinges, such as hinges 214. The PV module 202 includes hinges having different lengths and sizes. The foldable joints 212 allow the PV module 102 to transform between a collapsed configuration and an expanded configuration. The PV module 202 illustrated in FIG. 2 is in its expanded configuration.

The foldable joints 212 in the PV module 202 have a single DOF configuration such that each of the foldable joints 212 fold in unison and at the same time. In other words, the foldable joints 212 cannot bend or fold independently of each other; they all fold together.

The joints 212 may be engineered to align their rotational axes either coplanar with the front surface, coplanar with the back surface of the folding panels, or at an offset equivalent to approximately twice the thickness of the panels. Coplanarity with either the front or rear face of the panels may preserve the integrity of the module's single degree of freedom folding architecture. For instance, in the PV module 202, all diagonal folds have joint axes coplanar with the front face of the folding panels, while most vertical folds have joint axes coplanar with the rear face of the folding panels. Furthermore, at junctions known as degree-six vertex splits, the joints are positioned at a distance that is approximately double that of the panel's thickness from its rear, enabling precise and controlled folding. This intricate arrangement ensures the module remains rigidly foldable.

One or more solar cells are connected to the rigid panels 208. The solar cells on the PV module 202 are organized into solar cells 210, with one solar cell 210 being secured to each of the rigid panels 208. The solar cells 210 may be in electrical communication such that solar energy generated by the solar cells 210 on the PV module 202 may be consolidated and output to a port (not shown).

While the PV module 202 includes only one large solar cell 210 on each rigid panel 208 to approximate the area in which solar cells will be placed, any number of solar cells may be secured and arranged to a rigid panel. For example, FIG. 3 illustrates another embodiment of a PV module 302 according to the present disclosure. The PV module 302 includes a plurality of connected individual rigid panels 308 and a plurality of half-cut triangular solar cell wafers 310. Some of the panels 308 have only a single half-cut or quarter-cut solar cell wafer 310 secured to the panel, while other rigid panels 308 have two half-cut solar cells 310 secured. The solar cells 310 may be in electrical communication such that solar energy generated by the solar cells 310 on the PV module 302 may be consolidated and output to a port (not shown).

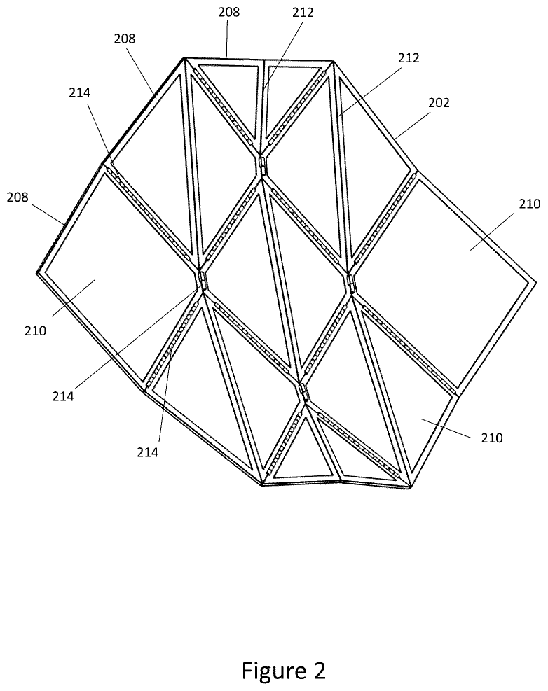

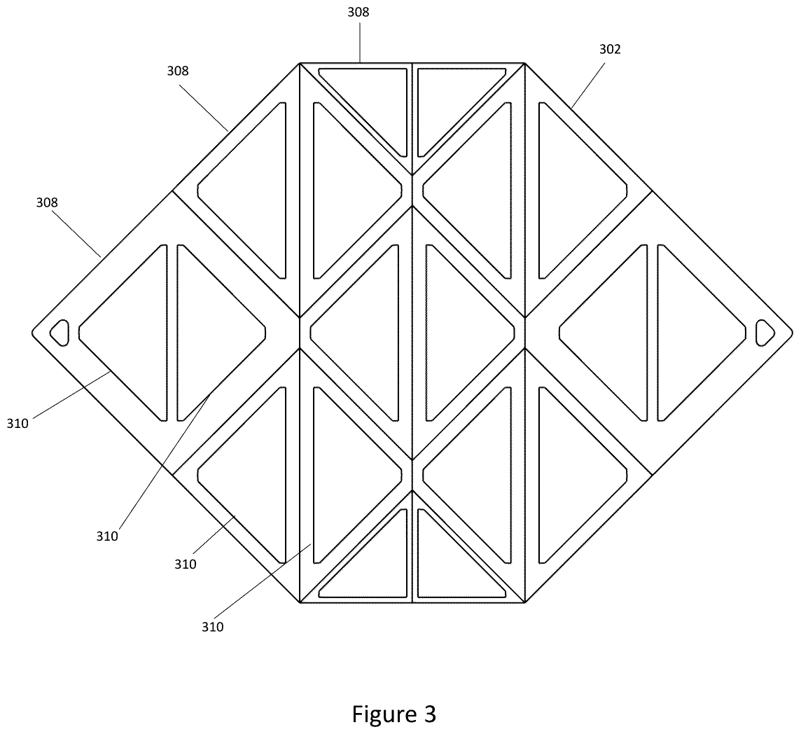

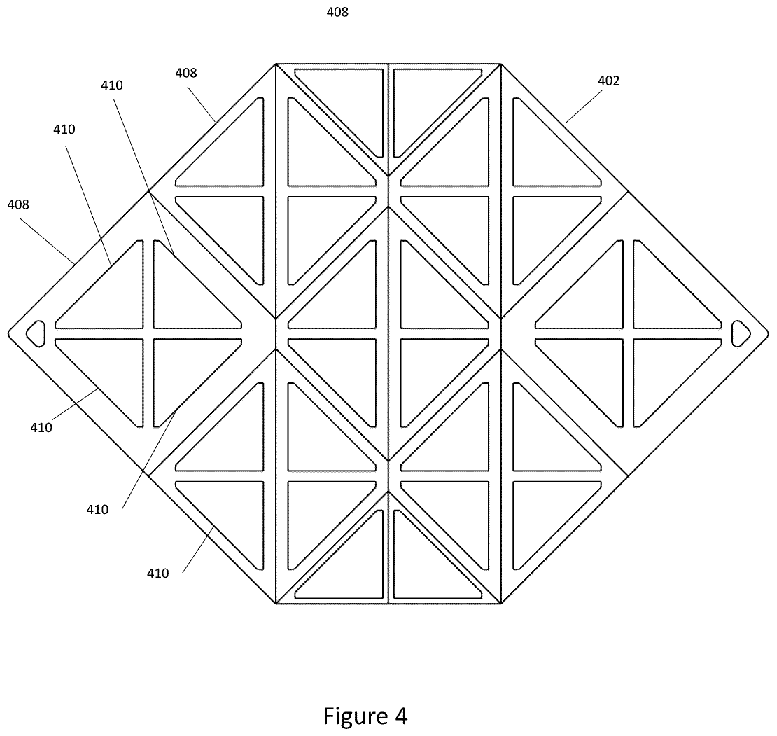

FIG. 4 illustrates another embodiment of a PV module 402 according to the present disclosure. The PV module 402 includes a plurality of connected individual rigid panels 408 and a plurality of solar cells 410. Some of the rigid panels 408 have a pair of quarter-cut solar cell wafers 410 secured to the panel, while other rigid panels 408 have four quarter-cut solar cells 410 secured. The solar panels 410 may be in electrical communication such that solar energy generated by the solar cells 410 on the PV module 402 may be consolidated and output to a port (not shown).

A critical factor in the design of solar cell configurations within the PV module is the adherence to a predefined ratio corresponding to the solar cell layout across different panel sizes, ensuring uniformity in voltage and current across the array. To illustrate, suppose large panels are designed with a layout ratio of 4; it follows that medium-sized panels should adopt a ratio of 2, and the smallest panels a ratio of 1. This systematic approach to scaling the solar cell arrangement across varying panel dimensions can be essential for maintaining electrical consistency—both current and voltage—throughout the module. Such a strategy allows for a multitude of configurations, including solar cells with square or triangular patterning, offering flexibility in design while securing the operational coherence of the solar cells across the module.

Mounting mechanisms, such as the mounting mechanism 104 shown in FIGS. 1A-1G, can serve a number of different functions. In addition to providing a mechanism for mounting a PV module to a stand, mounting mechanisms can also serve as electrical control boxes that output power generated by a PV module to a convenient output port. Furthermore, mounting mechanisms can also fix the panels in a PV module in an expanded configuration and prevent the joints from folding or moving toward the collapsed configuration.

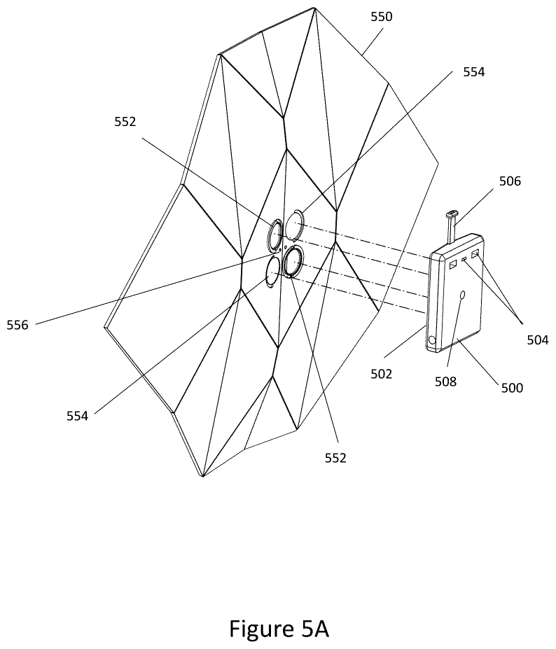

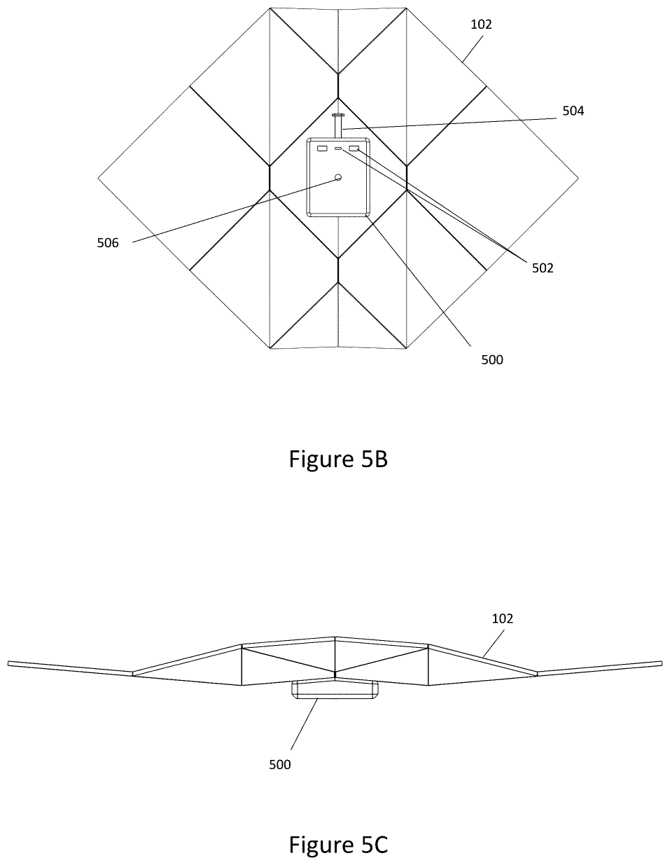

FIGS. 5A-5C illustrate another example mounting mechanism 500, which may be secured to the back of a PV module 550. FIG. 5A illustrates a rear perspective view with the mounting mechanism 500 not attached, FIG. 5B illustrates a back view of the PV module 550 with the mounting mechanism 500 attached, and FIG. 5C illustrates a top view of the PV module 550 with the mounting mechanism 500 attached. Similar to the PV module 102, the PV module 550 includes a plurality of interconnected panels have a single DOF folding configuration. The PV module 550 also includes magnets 552, recesses 554, and connection pins 556.

The mounting mechanism 500 is rectangular and includes magnets and protrusions (not shown) on a front face 502 that correspond with the magnets 552 and the recesses 554 on the PV module 550. The front face 502 also includes connection ports that interface with the connection pins 556. The power generated by solar cells on a front side of the PV module 550 may be transferred to the mounting mechanism 500, which also may act as an electrical control box, to convert the energy output from the PV cells into usable power through one or more ports 504, which may include USB type A, USB type C, DC power ports, etc.

The mounting mechanism 500 also includes a detaching mechanism 506 that is configured to break the attachment between the magnets on the PV module 550 and the magnets on the mounting mechanism 500. In one embodiment, the detaching mechanism 506 may rotate the magnets in the mounting mechanism 500 so that the polarity no longer creates an attraction between the magnets. For example, a rack and pinion system inside the mounting mechanism 500 may be used to rotate the magnets. In another embodiment, a detaching mechanism may simply create some space between the mounting mechanism 500 and the PV module 550 so that torque need not be applied to other panels that are not directly connected to the mounting mechanism 500 in the PV module 550 to separate the mounting mechanism 500 from the PV module 550. Torque applied to these other panels may cause damage to the PV module 550.

The front face 502 is not completely flat. As can be seen in FIG. 5C, the front face 502 includes two angled surfaces that correspond with the angles of the two panels on the PV module 550 to which the mounting mechanism 500 is secured, which allows a flush fit between the mounting mechanism 500 and the PV module 550. Because the mounting mechanism 500 spans between two separate panels on the PV module 550, this flush fit locks the interconnected panels of the PV module 550 in place and prevents them from altering their angular configurations relative to each other.

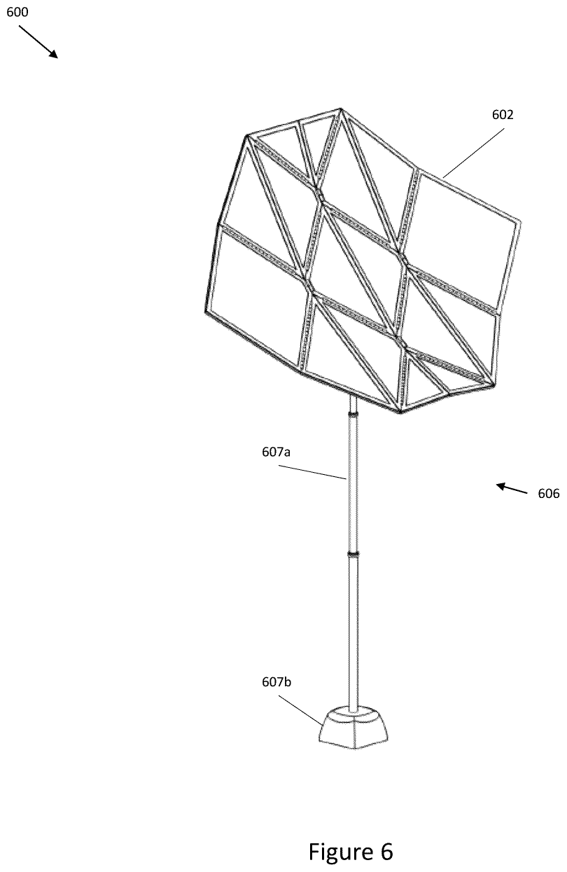

The mounting mechanism 500 also includes a stand port 508 that is configured to allow a stand to be secured to the mounting mechanism 500. The stand port 508 may be a threaded hole that allows a stand or a component that holds a stand to be secured thereto. For example, FIG. 6 illustrates a PV module system 600 that includes a PV module 602, a mounting mechanism (not shown), and a stand 606. The stand 606 may be secured to the PV module 602 through a stand port in the mounting mechanism. The stand 606 includes an elongated post 607a and a base section 607b.

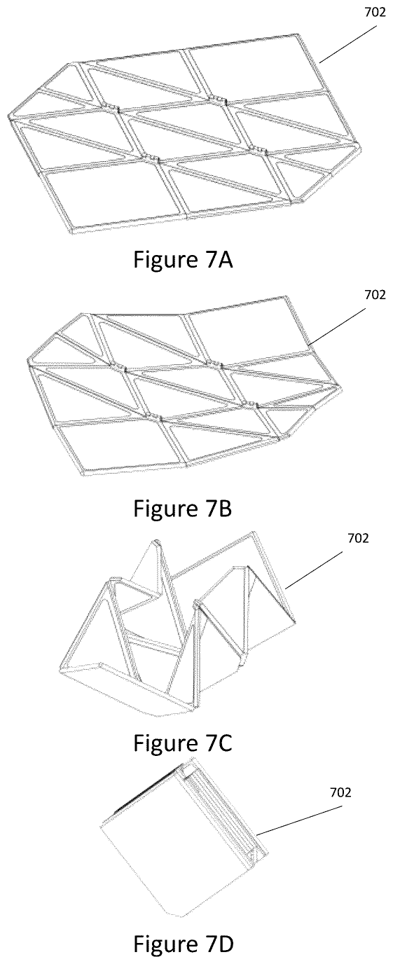

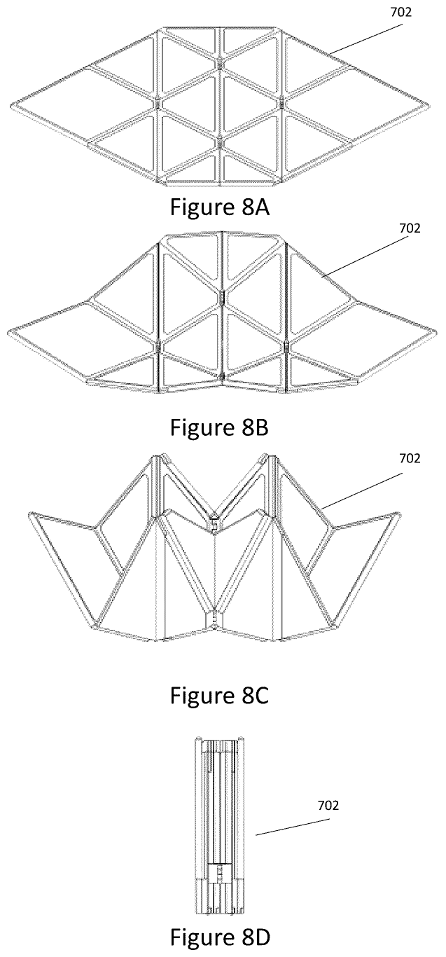

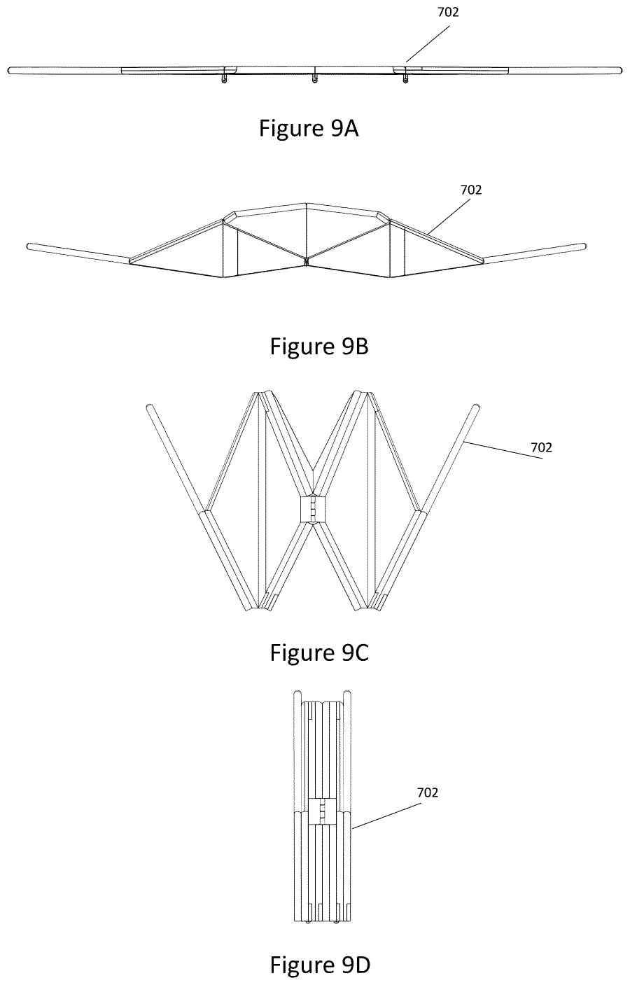

FIGS. 7A-7D, 8A-8D, and 9A-9D illustrate different views of a folding sequency of a PV module 702 according to the present disclosure. Specifically, FIGS. 7A-7D illustrate the folding sequence of the PV module 702 from a first perspective view. FIGS. 8A-8D illustrate the folding sequence of the PV module 702 from a second perspective view. FIGS. 9A-9D illustrate the folding sequence of the PV module 702 from a side view.

The PV module 702 includes a number of individual rigid panels interconnected through a plurality of folding joints. The PV module 702 also includes a number of solar cells that are secured to the rigid panels. The PV module 702 has a single DOF folding pattern such that each of the foldable joints fold in unison and at the same time. FIGS. 7A, 7B, 8A, 8B, 9A, and 9B show the PV module 702 in an expanded configuration. In FIGS. 7A, 8A, and 9A, the PV module 702 is completely flat while in FIGS. 7B, 8B, and 9B the foldable joints have a slight bend. FIGS. 7C, 8C, and 9C show the PV module 702 between a collapsed configuration and an expanded configuration.

FIGS. 7D, 8D, and 9D show the PV module 702 in a completely collapsed configuration. As can be seen in FIGS. 7D, 8D, and 9D, in the collapsed configuration, the PV module 702 forms a cube-like shape with imperfect square shapes at each end. For example, one corner on each of the square ends is truncated. Significantly, in the collapsed configuration, none of the panel surfaces that include solar cells are external or face outward. All of the panel surfaces that include solar cells are internal and face inward in a stacked arrangement. This configuration can help to protect the solar panel surfaces or solar cells from getting scratched or otherwise damaged when in the collapsed configuration.

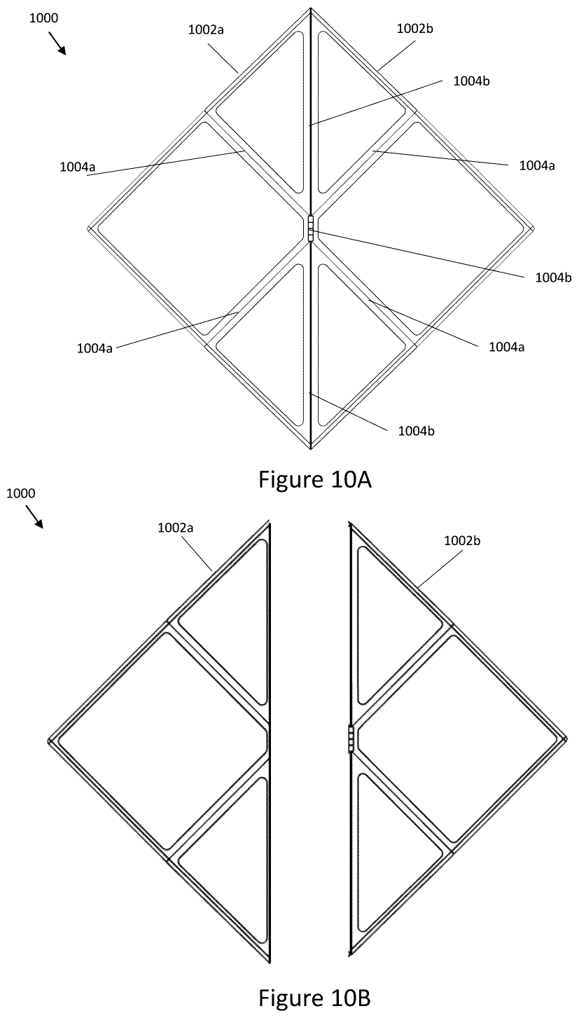

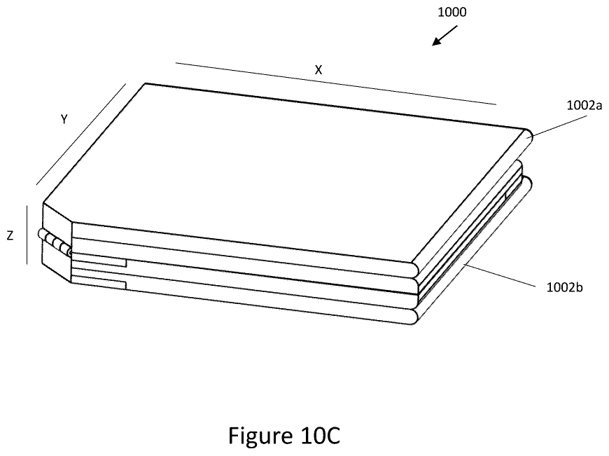

FIGS. 10A-10C illustrate another embodiment of a PV module 1000 according to the present disclosure. The PV module 1000 includes a first set of joined panels 1002a and a second set of joined panels 1002b. Each of the first and second sets of joined panels 1002a and 1002b include three individual panels that are interconnected through foldable joints 1004a. The first set of joined panels 1002a is secured to the second set of joined panels 1002b through a foldable joints 1004b. One of the foldable joints 1004b includes an offset hinge.

The foldable joints 1004b are not only foldable but are also selectively detachable to separate the first set of joined panels 1002a from the second set of joined panels 1002b, as shown in FIG. 10B. The first and second sets of joined panels 1002a and 1002b may be connected to each other via any number of interlocking attachment mechanisms. For example, the first and second sets of joined panels 1002a and 1002b may be connectable via a magnetic attachment, or by a snap, or latching mechanism. Similar to previous embodiments, solar cells may be secured to the panels of the first and second sets of joined panels 1002a and 1002b and may be in electrical communication such that solar energy generated by these solar cells may be consolidated to a single output point.

The foldable joints 1004a and 1004b have a single DOF configuration such that each of the foldable joints 1004a and 1004b in the PV module 1000 fold in unison and at the same time to transform the PV module 1000 between a collapsed configuration shown in FIG. 10A and a collapsed configuration shown in FIG. 10C. The largest panels in the first and second sets of joined panels 1002a and 1002b are the only panels having one side that is fully exposed in the collapsed configuration. The length, width, and height (x, y, and z) dimensions of the PV module 1000 in the collapsed configuration are also shown in FIG. 10C.

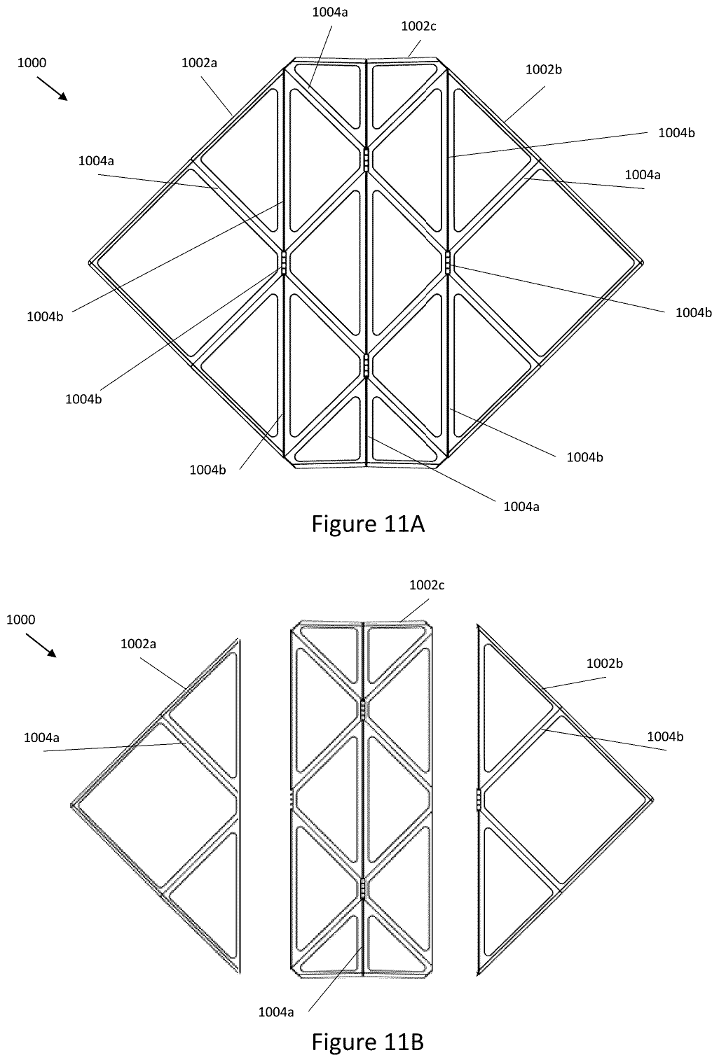

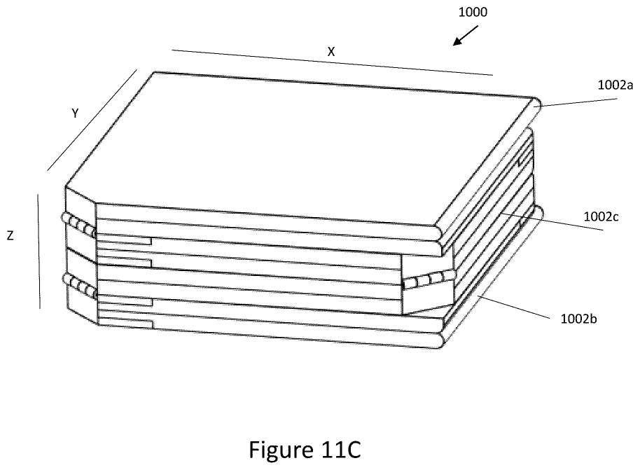

In order to increase the power generating capacity of the PV module 1000, additional sets of joined panels may be added to the PV module 1000. For example, FIGS. 11A, 11B, and 11C illustrate the PV module 1000 with first and second sets of joined panels 1002a and 1002b and an additional third set of joined panels 1002c. Like the first and second sets of joined panels 1002a and 1002b, the third set of joined panels 1002c includes a plurality of individual panels that are interconnected through foldable joints 1004a. The third set of joined panels 1002c is secured to the first and second sets of joined panels 1002a and 1002b through foldable joints 1004b. The third set of joined panels 1002c is rectangular in shape and has 10 individual panels of different sized polygonal shapes, including triangles and trapezoids. However, any shape of insert is possible with any number of individual panels having any number of different shapes.

The foldable joints 1004b are selectively detachable to separate the third set of joined panels 1002b from the first and second sets of joined panels 1002a and 1002b, as shown in FIG. 11B. Solar cells may be secured to the panels of the third set of joined panels 1002c, which may be in electrical communication with the solar cells secured to the panels of the first and second sets of joined panels 1002a and 1002b such that solar energy generated by these solar cells may be consolidated to a single output point.

The mobility of the third set of joined panels 1002c, also referred to as an insert, is synchronized with the first and second sets of joined panels 1002a and 1002b so that the PV module 1000 retains its single DOF configuration. Each of the foldable joints 1004a and 1004b in the PV module 1000 fold in unison and at the same time to transform the PV module 1000 between a collapsed configuration shown in FIG. 11A and a collapsed configuration shown in FIG. 11C. The length, width, and height (x, y, and z) dimensions of the PV module 1000 in the collapsed configuration with the third set of joined panels 1002c are also shown in FIG. 11C. The length and width (x and y) dimensions of the PV module 1000 are the same in FIGS. 10C and 10C. In other words, with or without the third set of joined panels 1002c, the length and width of the PV module 1000 in the collapsed configuration remain the same. Only the height (z) dimension of the PV module 1000 in the collapsed configuration increases when the PV module 1000 includes the third set of panels 1002c. In addition, with the exception of a few of its edges, the third set of joined panels 1002c is concealed in the collapsed configuration.

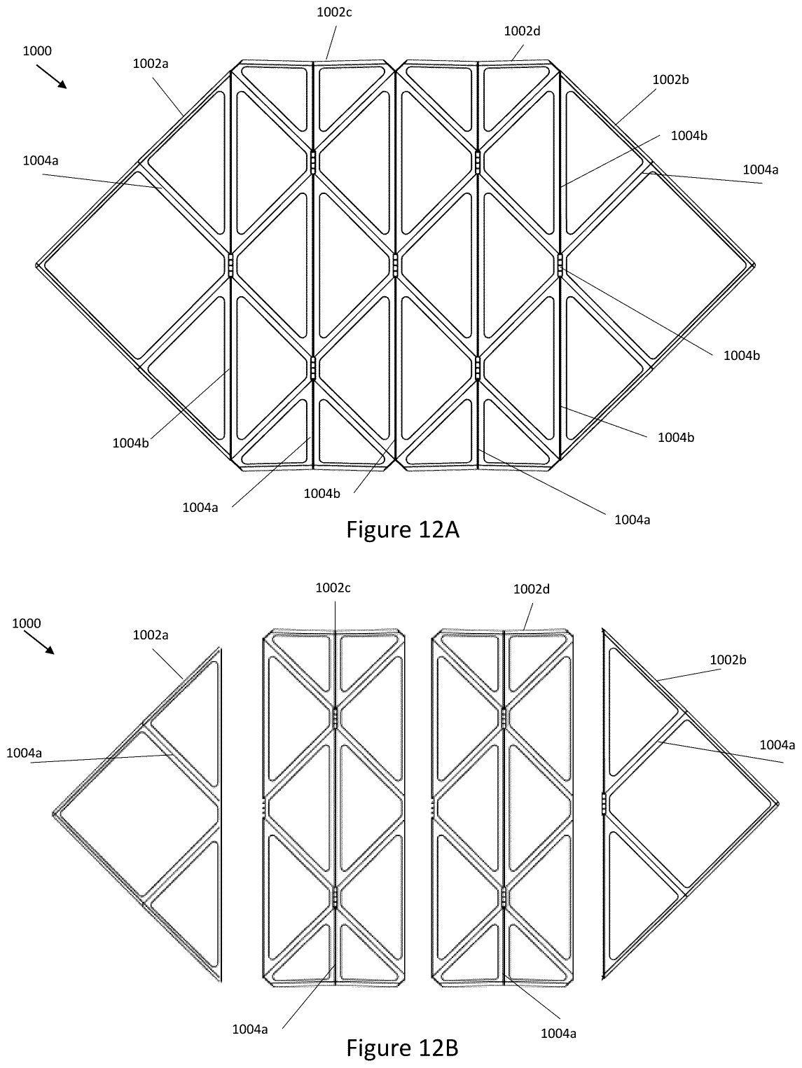

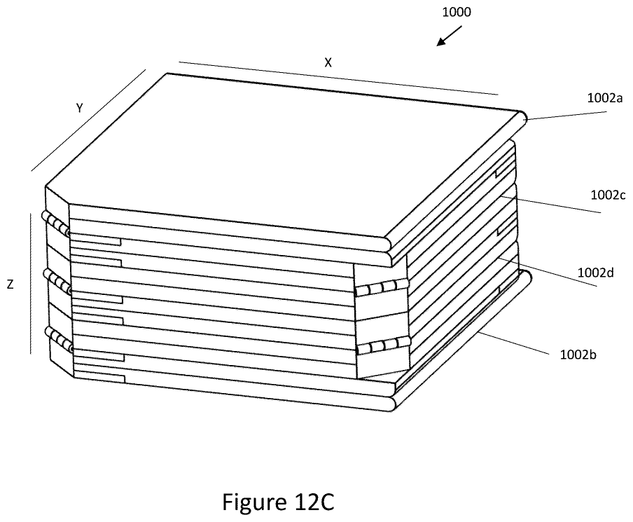

Any number of additional sets of inserts may be added to the PV module 1000. For example, FIGS. 12A, 12B, and 12C illustrate the PV module 1000 with first, second, and third sets of joined panels 1002a, 1002b, 1002c and an additional fourth set of joined panel 1002d, which is identical to the third set of joined panels 1002c. Like the first, second, and third sets of joined panels 1002a, 1002b, and 1002c, the fourth set of joined panels 1002d includes a plurality of individual panels that are interconnected through foldable joints 1004a. The fourth set of joined panels 1002d is secured between the second and third sets of joined panels 1002b and 1002c through foldable joints 1004b.

The foldable joints 1004b are selectively detachable to separate the first, second, third, and fourth sets of joined panels 1002a, 1002b, 1002c, and 1002d as shown in FIG. 12B. Solar cells may be secured to the panels of the fourth set of joined panels 1002d, which may be in electrical communication with the solar cells secured to the panels of the first, second, and third sets of joined panels 1002a, 1002b, and 1002c such that solar energy generated by these solar cells may be consolidated to a single output point.

The foldable joints 1004a and 1004b have a single DOF configuration such that each of the foldable joints 1004a and 1004b in the PV module 1000 fold in unison and at the same time to transform the PV module 1000 between a collapsed configuration shown in FIG. 12A and a collapsed configuration shown in FIG. 12C. The length, width, and height (x, y, and z) dimensions of the PV module 1000 in the collapsed configuration with the third and fourth sets of joined panels 1002c and 1002d are also shown in FIG. 12C. The length and width (x and y) dimensions of the PV module 1000 are the same in FIGS. 10C, 11C, and 12C. Only the height (z) dimension of the PV module 1000 in the collapsed configuration increases when the PV module 1000 includes the fourth set of joined panels 1002d.

As the number of inserts increases, the amount of wattage that the PV module is able to generate also increases. The exact amount of increase in wattage that a PV module may gain by including an insert will vary based on the size of the insert. However, in some embodiments, each insert may increase the amount of wattage by approximately the amount of wattage that the two end sections are able to generate. For example, in FIGS. 10A-10C the first and second sets of joined panels 1002a and 1002b are capable of securing solar cells that may generate approximately 10 watts of power. In FIGS. 11A-11C the first, second, and third sets of joined panels 1002a, 1002b, and 1002c are capable of securing solar cells that may generate approximately 20 watts of power. In FIGS. 12A-12C the first, second, third, and fourth sets of joined panels 1002a, 1002b, 1002c, and 1002d are capable of securing solar cells that may generate approximately 30 watts of power. These wattage values are just an example, and the ratio of power produced is the important principal.

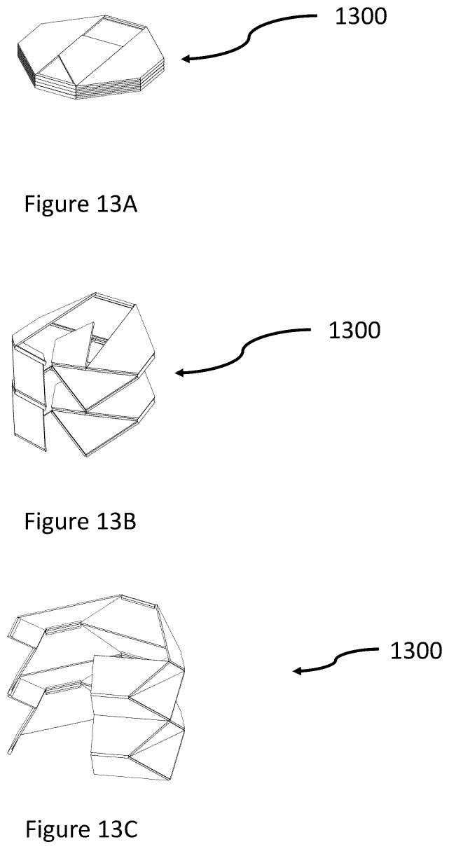

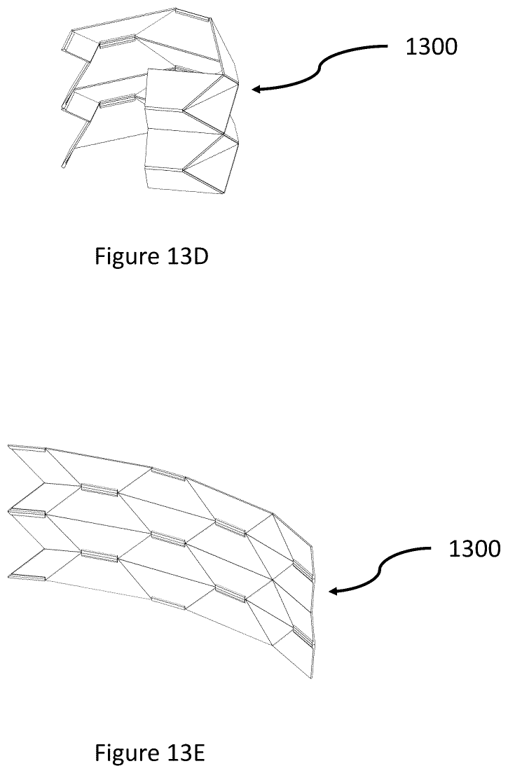

FIGS. 13A-13E illustrate a folding sequence from a first perspective of another PV module 1300 according to the present disclosure. FIG. 13A illustrates the PV module 1300 in a first configuration in which the PV module 1300 is in a folded or collapsed configuration. As can be seen in FIG. 13A, PV module 1300 has a two-dimensional (x and y axes) octagonal shape in its collapsed configuration. FIG. 13E illustrates the PV module 1300 in a second configuration in which the PV module 1300 is in an unfolded or open configuration. FIGS. 13B-13D illustrates the PV module 1300 between the folded or collapsed configuration and the unfolded or open configuration.

In the PV module 1300, additional rows (sequences of 6 panels) may be added to the top or bottom of the module to increase the surface area of the module and potential wattage. Each additional row may result in an increased height (z axis) in the collapsed configuration of the module. However, additional panels will not alter the length and width (x and y) dimensions of the octagonal shape of the PV module in the collapsed configuration. When unfurling from a collapsed to an unfurled configuration, module 1300 the motion follows one degree of freedom.

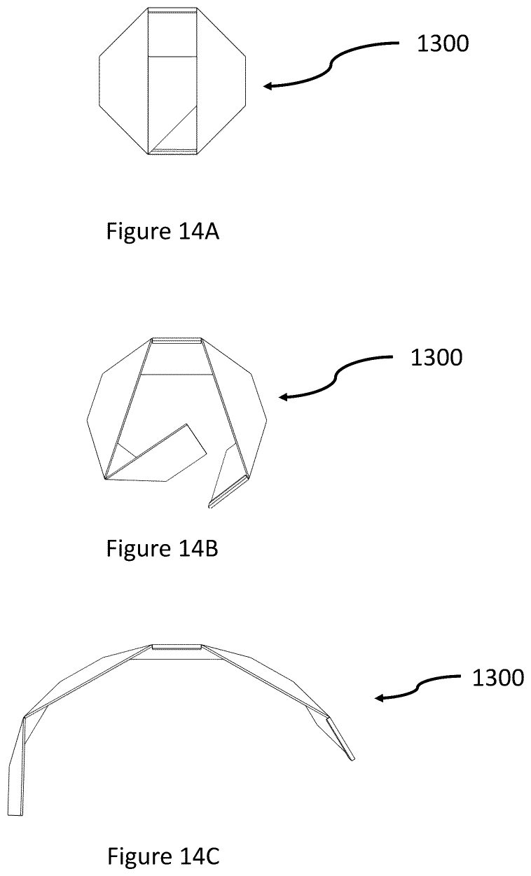

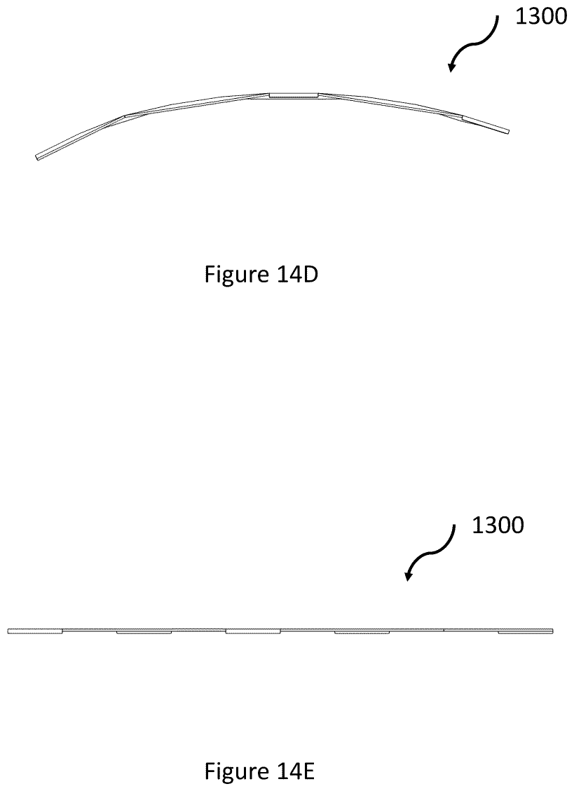

FIGS. 14A-14E illustrate the folding sequence of the PV module 1300 from a second perspective. FIG. 14A illustrates the PV module 1300 in a first configuration in which the PV module 1300 is in a folded or collapsed configuration. FIGS. 14D and 14E illustrate the PV module 1300 in a second configuration in which the PV module 1300 is in an unfolded or open configuration, with the PV module 1300 being completely flat in FIG. 14E. FIGS. 14B and 14C illustrate the PV module 1300 between the folded or collapsed configuration and the unfolded or open configuration.

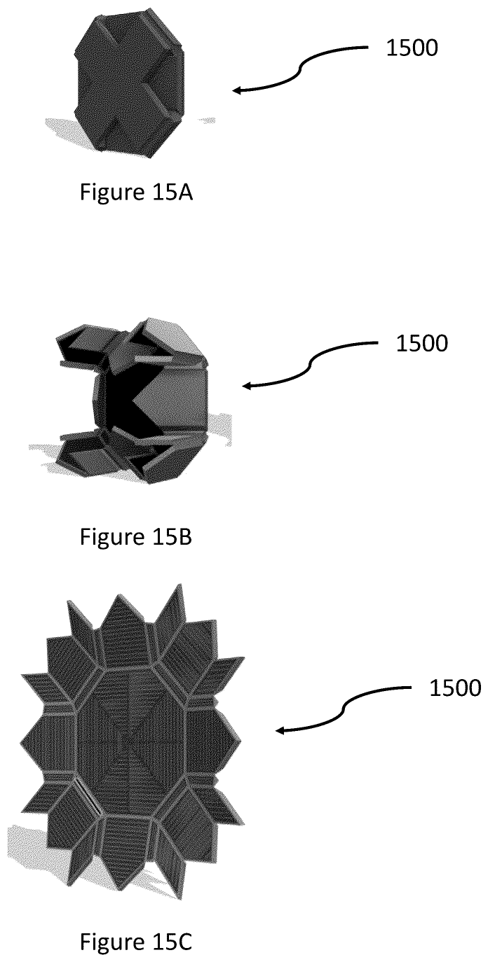

FIGS. 15A-15C illustrate a PV module 1500 according to the present disclosure. FIG. 15A illustrates the PV module 1500 in a first configuration in which the PV module 1500 is in a folded or collapsed configuration. As can be seen in FIG. 15A, PV module 1500 has a two-dimensional (x and y axes) octagonal shape in its collapsed configuration. FIG. 15C illustrates the PV module 1500 in a second configuration in which the PV module 1500 is in an unfolded or open configuration. FIG. 15B illustrates the PV module 1500 between the folded or collapsed configuration and the unfolded or open configuration. When unfurling from a collapsed to an unfurled configuration, module 1500 the motion follows one degree of freedom.

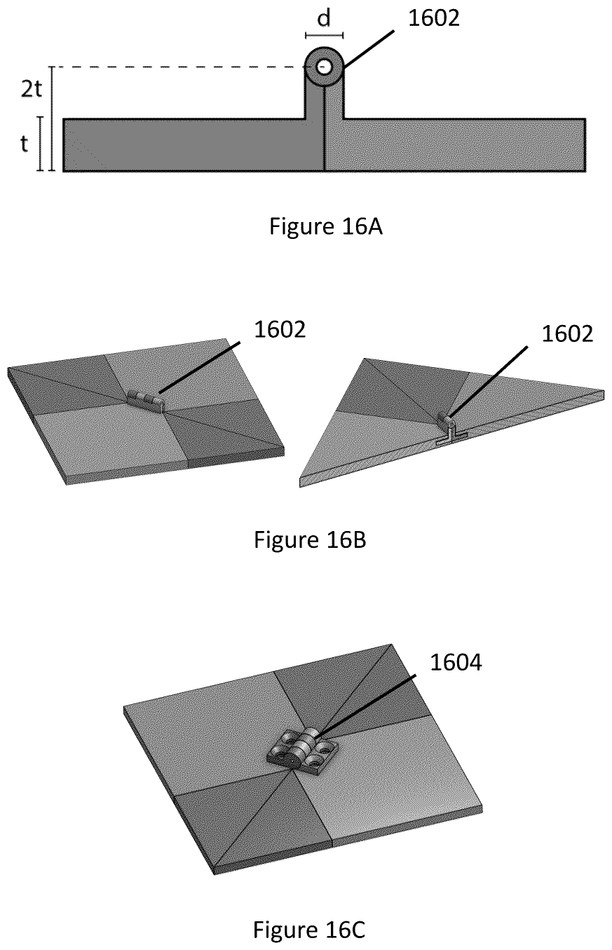

FIGS. 16A-16C illustrate various offset hinges for accommodating panels having different thicknesses. The panels have a thickness=t. At each vertex split, an offset hinge (such as hinge 1602 and 1604) is added with the center of rotation offset by approximately the thickness of the panel, t, from the face of the panel. Vertex splits may make angled unidirectional creases non-collinear. It may also make the non-zero thickness design rigid foldable. This allows kinematic equivalence when folding rigid panels with non-zero thickness. The PV module 102 shown in FIGS. 1A-1G illustrates a PV module with multiple visible offset hinges.

Regarding flexible membrane folds, a plurality of rigid or semi-rigid panel elements may be laminated with a thin flexible substrate, or membrane, at crease locations. These panel elements may have any number of different shapes, including trapezoidal and isosceles trapezoid. The creases/folds may include embedded electrical ribbon connectors. The electrical connections vary which side of the panel they are on depending on which side of the panel the joint folds (either on the top of bottom). Electrical ribbon connections are coplanar with the top face of the panel for valley folds and coplanar with the bottom face of the panel for mountain folds. A plurality of panels may be aligned with a continuous sheet, membrane, or laminate that joins all panels together, with non-rigid regions acting as a folding hinge (rather than traditional hinges and assembly). Hinges or membrane folds may be designed with biased bending, using stored strain energy in the membrane folds or torsional springs, guiding the panel deployment to a concealed or open position. In an open or expanded configuration, where the module is flat or nearly flat, when there is no mechanical advantage, torsional springs may be embedded in the joints that are configured to help guide the module back to the closed position. Alternatively, the reverse can also be true. The module could be “locked” in the closed or collapsed configuration, and upon release, the torsional springs or biased membrane hinges automatically deploy the module to the open or expanded configuration.

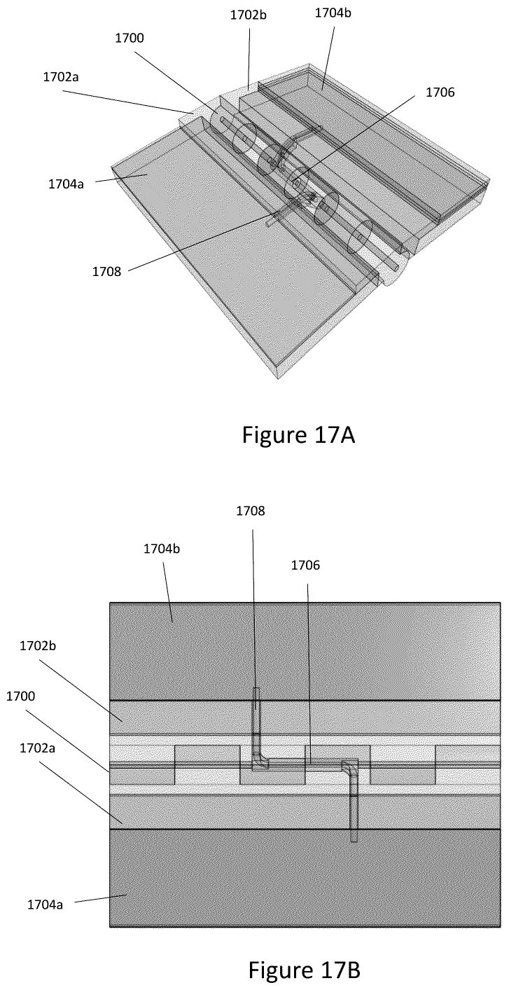

Mechanical hinges, such as those shown in FIGS. 16A-16C, may include, in whole or in part, hollow channels that permit passage of a length of electrical wire. This design may facilitate torsional bending over a length of wire instead of at a localized point. This may enhance the fatigue life cycle of the wires by distributing stress more evenly across a larger portion of wire and reducing localized strain. FIGS. 17A and 17B illustrate a hinge 1700 between two panels 1702a and 1702b that have solar cells 1704a and 1704b attached. The hinge 1700 includes a channel 1706 through which a wire 1708 passes. Ends of the wire 1708 extend out of the hollow channel to contact the solar cells 1704a and 1704b, thereby electrically connecting the solar cells 1704a and 1704b. When the panels 1702a and 1702b fold, the wire 1708 does not bend at a single point but is spread across the length of wire that is within the channel 1706.

Photovoltaic cells, which may also be referred to as solar cells, may be configured in a best fit manner to cover the surface of the non-rectangular, irregular quadrilateral shape. The photovoltaic cells may be placed on the inside panel face so that when folded, the solar cell side is covered and protected. Alternatively, photovoltaic cells may also be placed on the opposite side.

Thickness accommodation regions could house an embedded stand that folds out to lean the panels against once deployed. This area could also be used to store embedded battery packs.

Contact switches could also be used instead of ribbon electrical connections, where circuits are open when the panels are deployed and contact is made with neighboring panels, but circuit is closed when the panels begin to fold.

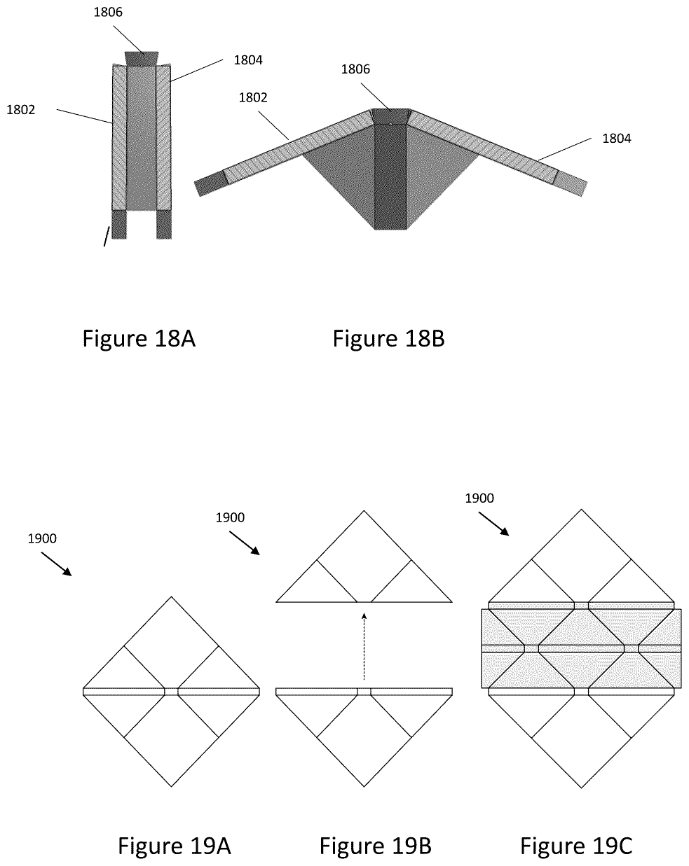

Contact regions may be angled and act as a hard stop to prevent the PV module from opening completely flat so that some mechanical advantage is maintained to easily close the module. This exaggerated configuration is illustrated in FIGS. 18A, which shows panels 1802 and 1804 in a collapsed configuration. FIG. 18B illustrates the panels 1802 and 1804 in an expanded configuration with a restraining block 1806 preventing the panels 1802 and 1804 from opening to a completely flat orientation. The restraining block causes the PV module to have a slightly concave shape in the expanded configuration.

A PV module 1900 with alternative rigid foldable folding pattern with all joint axis being coplanar is shown in FIGS. 19A-19C. This folding pattern introduces additional panels and results in a single layer with the hinge axes coplanar on one side of the panel, rather than requiring an offset hinge. This introduces small additional rigid panel segments to accommodate for thickness when folding. This approach allows everything to be only a single plane rather than having an offset hinge location. A single continuous piece of fabric or membrane can be added to the aligned rigid panels with a membrane, flexible laminate, or living hinges at the fold locations. This pattern would also allow the solar cell side to be concealed/protected when closed.

In accordance with common practice, the various features illustrated in the drawings may not be drawn to scale. The illustrations presented in the present disclosure are not meant to be actual views of any particular apparatus (e.g., device, system, etc.) or method, but are merely example representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

1. A photovoltaic (PV) module comprising:
a plurality of rigid panels; and
a plurality of solar cells secured to the plurality of rigid panels, wherein the plurality of rigid panels are connected through foldable joints and arranged relative to each other to enable folding with a single degree of freedom such that each of the foldable joints fold synchronously to transform the PV module between a collapsed configuration and an expanded configuration.

2. The PV module of claim 1, wherein in the expanded configuration, each of the solar cells in the plurality of solar cells face a common direction.

3. The PV module of claim 1, wherein each rigid panel in the plurality of rigid panels includes at least one solar cell.

4. The PV module of claim 3, wherein the solar cells are in electrical communication.

5. The PV module of claim 1, wherein the foldable joints include at least one hinge.

6. The PV module of claim 1, wherein in the collapsed configuration the PV module has a substantially square two-dimensional shape.

7. The PV module of claim 6, wherein the substantially square two-dimensional shape has a truncated corner.

8. The PV module of claim 1, wherein surfaces of only two rigid panels are exposed in the collapsed configuration with surfaces of all other rigid panels being folded inward and concealed within a stacked arrangement.

9. The PV module of claim 1, further comprising a restraining block in at least one foldable joint that prevents the rigid panels from having a completely flat shape in the expanded configuration.

10. The PV module of claim 9, wherein the PV module has a concave shape in the expanded configuration.

11. A photovoltaic (PV) module comprising:
a first set of joined panels including two or more rigid panels connected through one or more first foldable joints;
a first set of solar cells secured to the rigid panels in the first set of joined panels;
a second set of joined panels including two or more rigid panels connected through one or more second foldable joints;
a second set of solar cells secured to the rigid panels in the second set of joined panels, wherein:
the first set of joined panels is selectively attachable to second set of joined panels, and
when in an attached configuration, the first foldable joints and the second foldable joints have a single degree of freedom such that each of the first and second foldable joints fold synchronously to transform the PV module between a collapsed configuration and an expanded configuration.

12. The PV module of claim 11, wherein the first set of joined panels is selectively attachable to the second set of panels through an interlocking connection mechanism.

13. The PV module of claim 11, wherein the PV module includes a third set of joined panels that can be selectively attached between the first and second sets of joined panels to form part of the PV module.

14. The PV module of claim 13, wherein:
the PV module, in the collapsed configuration and without the third set of panels, has a first length, a first height, and a first width;
the PV module, in the collapsed configuration and with the third set of panels, has a second length, a second height, and a second width; and
the first and second lengths and the first and second heights are the same.

15. The PV module of claim 13, wherein:
the first set of joined panels, in the expanded configuration, have a triangular shape;
the second set of joined panels, in the expanded configuration, have a triangular shape; and
the third set of joined panels, in the expanded configuration, have a rectangular shape.

16. The PV module of claim 13, wherein the third set of joined panels is selectively attachable to the first and second sets of panels through magnetic connection mechanisms.

17. The PV module of claim 13, wherein the third set of joined panels approximately doubles an amount of wattage that the first and second sets of solar cells are capable of generating.

18. The PV module of claim 13, wherein in the collapsed configuration, surfaces of the third set of joined panels are internal facing.

19. The PV module of claim 11, wherein the foldable joints include at least one hinge.

20. The PV module of claim 11, wherein in the expanded configuration, each of the solar cells secured to the first and second sets of rigid panels face a common direction.
